(19) United States
(12) Patent Application Publication
(10) Pub. No.: US 2013/0236301 A1
(43) Pub. Date: Sep. 12, 2013

(54) Apparatus And System For Directing Hot Gas

(71) Applicants: Wei Chen, Greer, SC (US); Stacy Ann Holzman, Simpsonville, SC (US); Keith Cletus Belsom, Laurens, SC (US); Ronald James Chila, Greenfield Center, NY (US); Richard Martin DiCintio, Simpsonville, SC (US)

(72) Inventors: Wei Chen, Greer, SC (US); Stacy Ann Holzman, Simpsonville, SC (US); Keith Cletus Belsom, Laurens, SC (US); Ronald James Chila, Greenfield Center, NY (US); Richard Martin DiCintio, Simpsonville, SC (US)

(73) Assignee: General Electric Company, Schenectady, NY (US)

(21) Appl. No.: 13/416,559

(22) Filed: Mar. 9, 2012

(51) Int. Cl. F01D 1/04; F02C 7/12; F04D 29/54

(52) U.S. Cl. 415/185; 415/208.1; 60/806

(57) ABSTRACT

Disclosed herein are apparatuses and systems for directing the flow of hot gas exiting a transition piece. In an embodiment, an aft frame an aft frame has an exit face that has an airfoil shape. In an embodiment, a transition piece aft exit has an airfoil shape.

### TECHNICAL FIELD

The subject matter disclosed herein relates generally to combustion systems and more specifically hot gas flow.

### BACKGROUND

A typical gas turbine includes a plurality of combustors. The combustors receive a combustible fuel from a fuel supply and compressed air from a compressor that is driven by a shaft. For each combustor, the fuel is combusted in the compressed air within a combustion chamber defined by a combustor liner to produce hot combustion gas that is expanded through a turbine to produce work for driving a shaft. The hot combustion gas is conveyed from the combustor liner to the turbine by a transition piece or duct. The hot combustion gas flowing through the transition piece subjects the duct structure to very high temperatures. Hot gases circulated back towards the transition piece aft frame can cause damage, such as cracking.

The fielded product life cycle of the transition piece has been limited by the cracking observed in the aft frame. The cracking may impart significant repair costs and reduce the overall cycle life of the part.

### BRIEF DESCRIPTION OF THE INVENTION

Disclosed herein are apparatuses and systems for directing the flow hot gas exiting a transition piece. In an embodiment, an apparatus at the aft exit of the transition piece has a face with an airfoil shape. In another embodiment, a transition piece aft exit has an airfoil shape. In yet another embodiment, a system comprises a first aft frame with an airfoil shape on the exit face and a second aft frame in proximity to the first aft frame, wherein the second aft frame has an airfoil shape on the exit face.

This Brief Description of the Invention is provided to introduce a selection of concepts in a simplified form that are further described below in the Detailed Description. This Brief Description of the Invention is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

These and other features, aspects, and advantages of the present subject matter will become better understood when the following detailed description is read with reference to the accompanying drawings, wherein:

FIG. 1 is a side view of a gas turbine transition piece;

FIG. 2 is a perspective view a transition piece aft frame;

FIG. 3 is a perspective cut view of an airfoil shape aft frame exit;

FIG. 4 is a front view of an aft frame;

FIG. 5 is a cross section taken along the line 401-401;

FIG. 6 is a front view of adjacent transition pieces with the aft looking forward;

FIG. 7 is a cross section taken along the 601-601;

FIG. 8 is a cross section of adjacent aft frames;

FIG. 9 is an exemplary hot gas flow off of adjacent aft frames with a blunt face;

FIG. 10 is an exemplary hot gas flow off of adjacent aft frames with an airfoil shape;

FIG. 11 is an exemplary hot gas flow off of adjacent aft frames with an airfoil shape;

FIG. 12 is a cross section of adjacent aft frames;

FIG. 13 is a front view of an aft frame;

FIG. 14 is a cross section taken along the line 1301-1301;

FIG. 15 is a cross section taken along the line 1302-1302;

FIG. 16 is a partial a cross section of an airfoil shaped aft frame with a cooling hole;

FIG. 17 is a cross section of adjacent aft frames with an airfoil shape; and

FIG. 18 is a cross section of adjacent aft frames with a spoiler.

### DETAILED DESCRIPTION OF ILLUSTRATIVE EMBODIMENTS

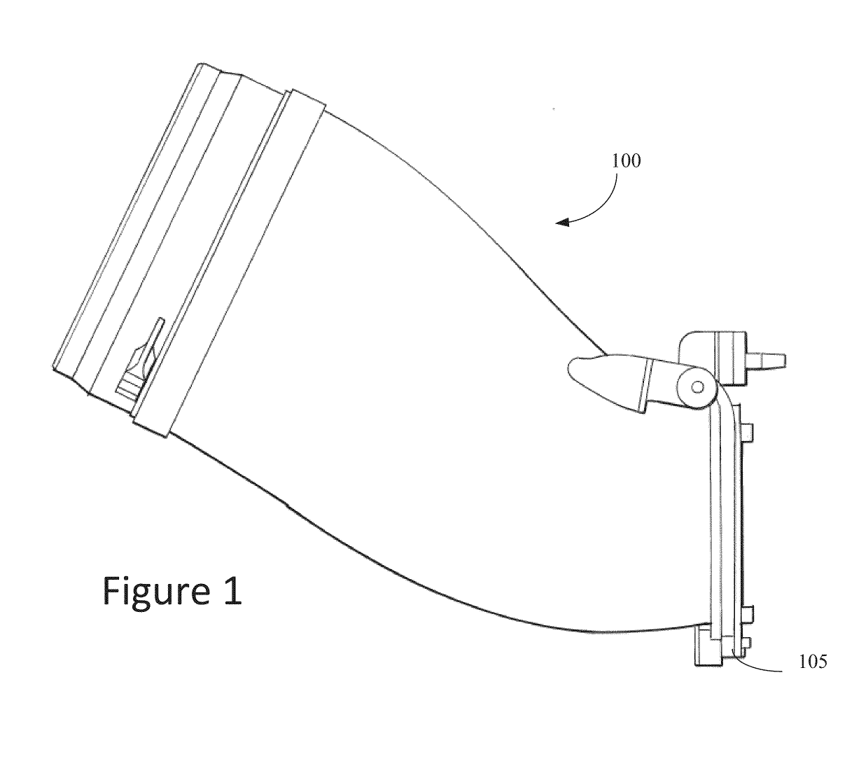

FIG. 1 shows an exemplary transition piece. Transition piece 100 may be coupled at an upstream end to a combustor and at a downstream or aft end to a turbine. The transition piece 100 carries hot gas flow from the combustor to the turbine. The aft frame 105 is a component which is located at the exit or aft end of the transition piece and thus acts as an interface between the transition piece 100 and the stage 1 nozzle. The aft frame 105 is exposed to hot gases flowing into the stage 1 nozzle.

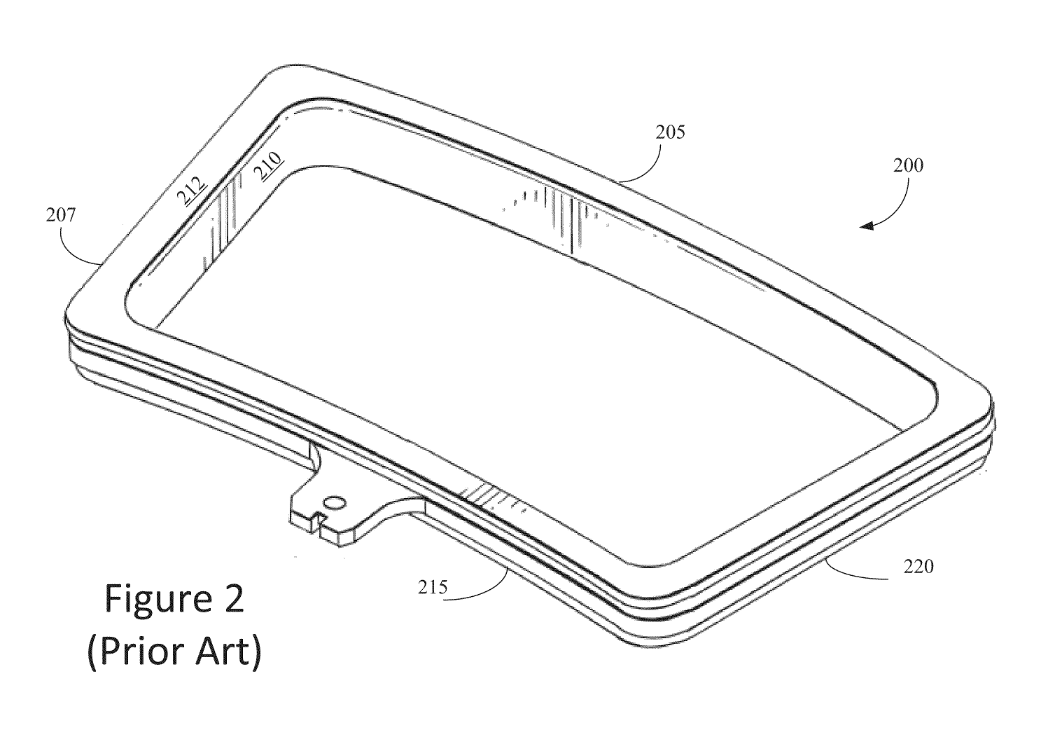

FIG. 2 is an exemplary, prior art embodiment of an aft frame. Aft frame 200 has an aft face 212 and inside wall 210. Inside wall 210 intersects with face 212 at a sharp, approximate 90 degree, angle. Aft frame 200 has a top rail 205 and bottom rail 215 as well as a left side rail 207 and right side rail 220.

A potential cause of thermal distress of prior art aft frame side rails may be due to ingestion of hot gas exiting the transition piece, trapping the hot gas and recirculating it between the stage one nozzle vane and aft face of the aft frame.

For example, with reference to FIG. 2, as typical in the prior art, the aforementioned ingestion may be deflected back towards the aft face 212 of the transition piece aft frame 200 because of the circumferential proximity of the stage one nozzle vane to the aft frame 200 and the blunt body effects of the aft face 212, which is normal to the aft frame inner wall 210 in the direction of transition piece exit flow. As disclosed herein, the shape of the aft frame side rails (or the entire perimeter of the aft frame) may be altered to minimize hot gas recirculation.

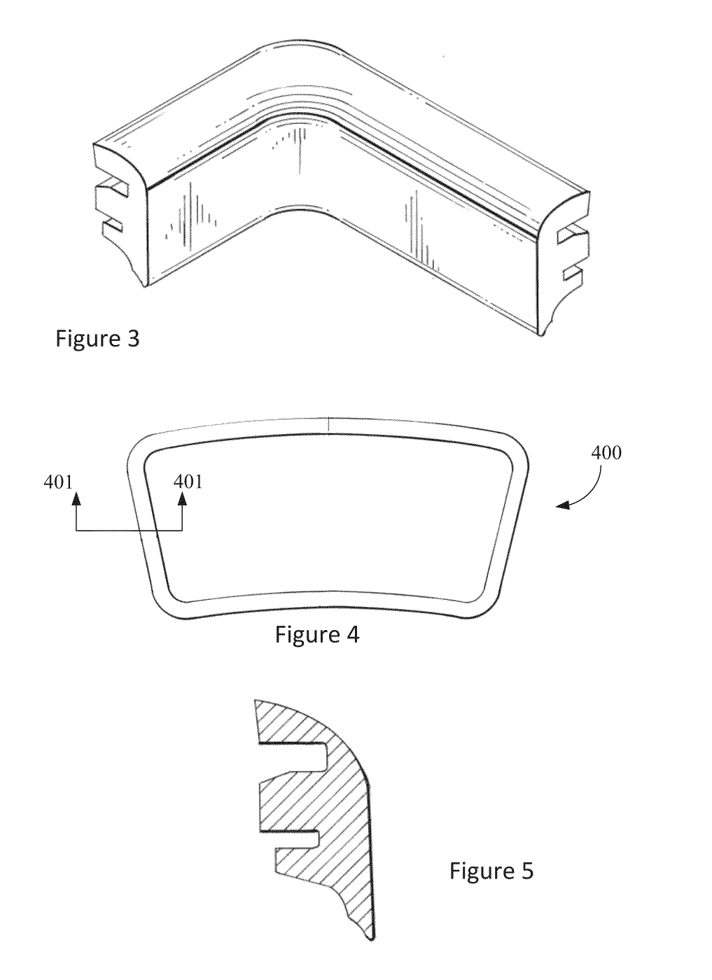

In an embodiment, the prior art shape of the transition piece aft frame face and the normal aft frame inner wall may be changed to create an airfoil shape on each of the aft frame side rails. FIG. 3 is an exemplary cut corner perspective view of an aft frame with a contoured or rounded airfoil face. FIG. 4 is an exemplary front view of an aft frame 400 with a contoured aft face. FIG. 5 is a cross section taken along line 401-401 of FIG. 4.

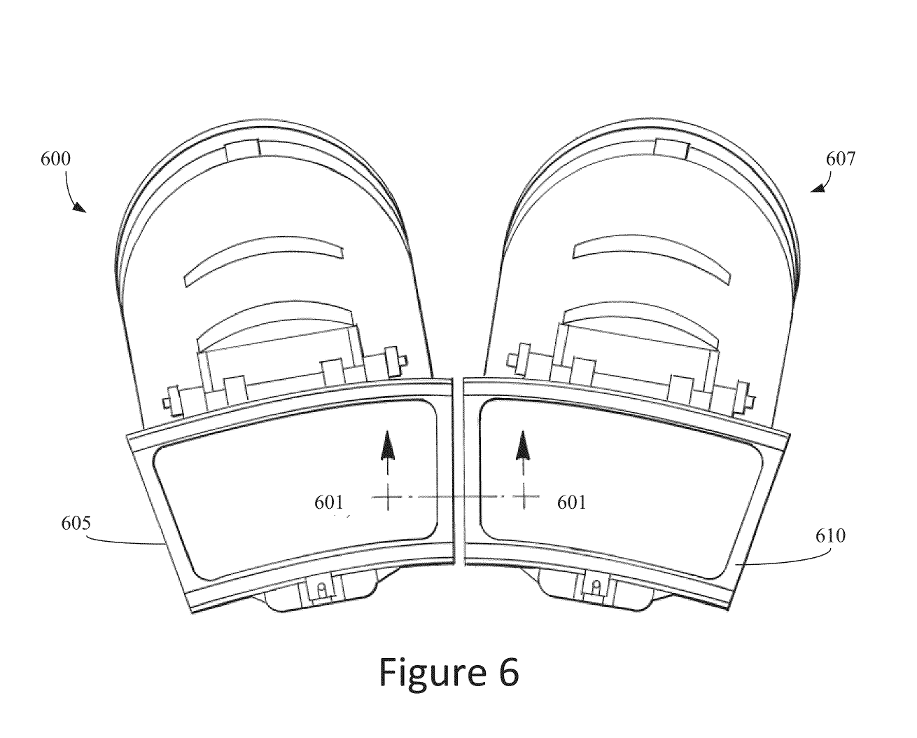

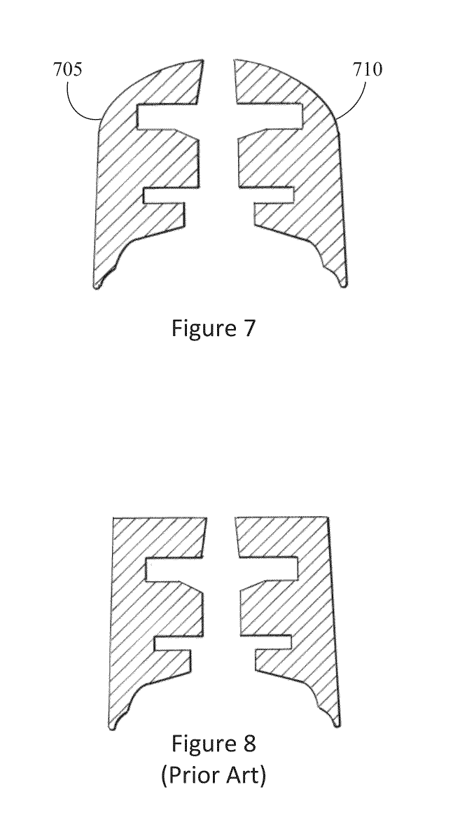

A gas turbine configuration may allow for adjacent transition pieces and corresponding aft frames. With reference to FIG. 6, transition piece 600 and corresponding aft frame 605 may be adjacent to transition piece 607 and corresponding aft frame 610. FIG. 7 is an exemplary cross section taken along line 601-601 of FIG. 6. In FIG. 7, 705 corresponds to aft frame 605 and 710 corresponds to aft frame 610. FIG. 8 is an exemplary cross section of adjacent aft frames from the prior art with inner walls normal to the aft frame front exit.

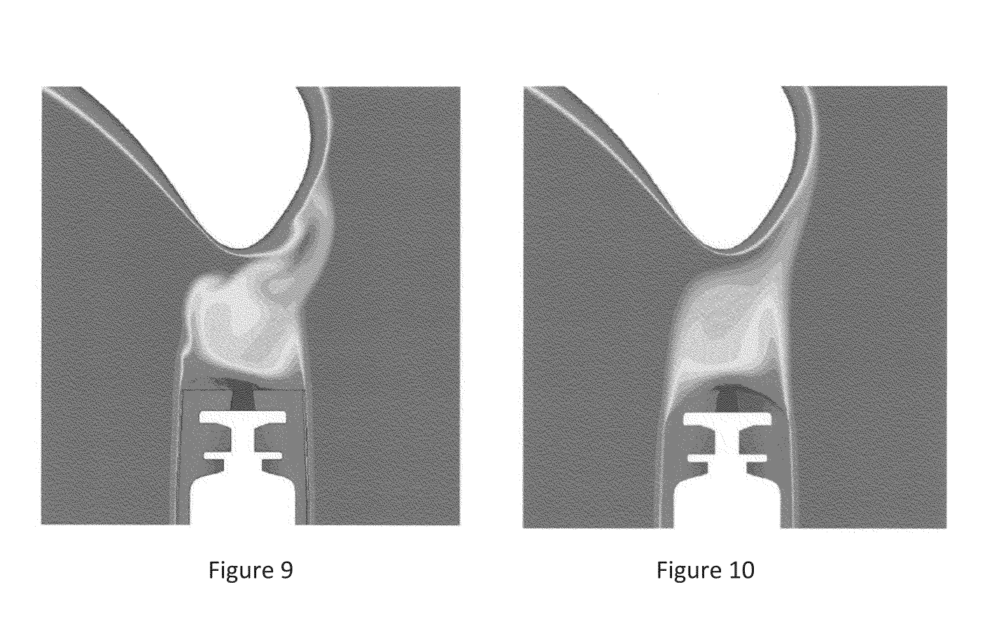

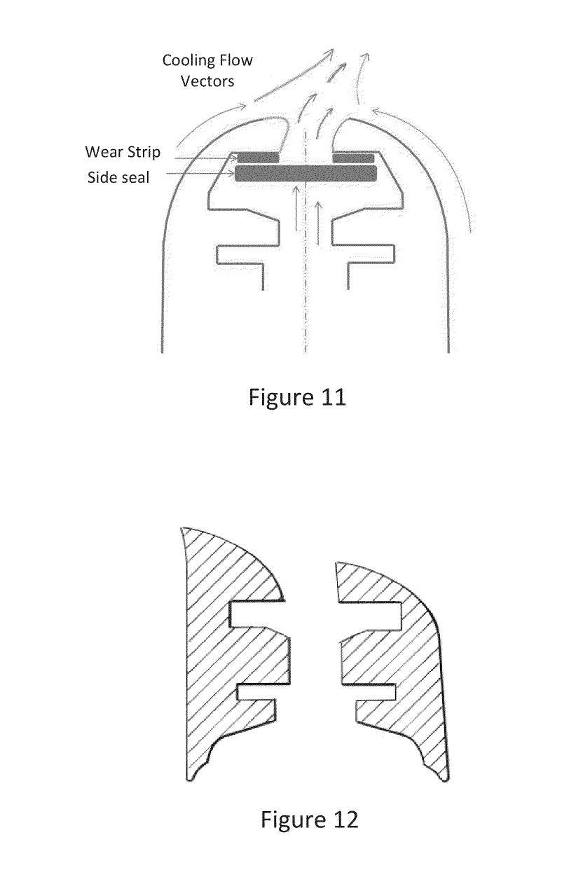

Transition piece aft frames configured as shown in FIG. 8 may create a large bluff body with their side spans when assembled side by side within the gas turbine. As stated herein, this aft frame configuration may create a recirculation zone that when positioned upstream of a stage one nozzle can circulate hot gases back towards the transition piece aft frame and cause damage. Aft frames with an airfoil shape (e.g., a contour), as shown in FIG. 7, may reduce the recirculation zone. FIGS. 9 and 10 are representations of computational flow dynamics contours. FIG. 9 is an exemplary illustration of the wake of a flat aft frame face (e.g., FIGS. 2 and 8). FIG. 10 is an exemplary illustration of a wake of contour shape aft frame face (e.g., FIGS. 3 and 7). The wake of the adjacent aft frames with a contoured aft frame face in FIG. 10 is more stable than the wake of the flat face aft frame in FIG. 9. FIG. 11 is an exemplary illustration of cross section of adjacent contoured aft frames and arrows showing an exemplary flow of cooling vectors. The cooling air pushes hot gases away from the cavities between hardware.

FIG. 12 is an exemplary embodiment of an asymmetrical air foil shape of a cross section of adjacent aft frames. To further optimize the flow field and minimize ingestion, the inner diameter of two adjacent side rails of adjacent aft frames may be tapered in the same direction (creating an asymmetric aft frame). The adjacent aft frame taper may be based on the taper of the stage one nozzle vane.

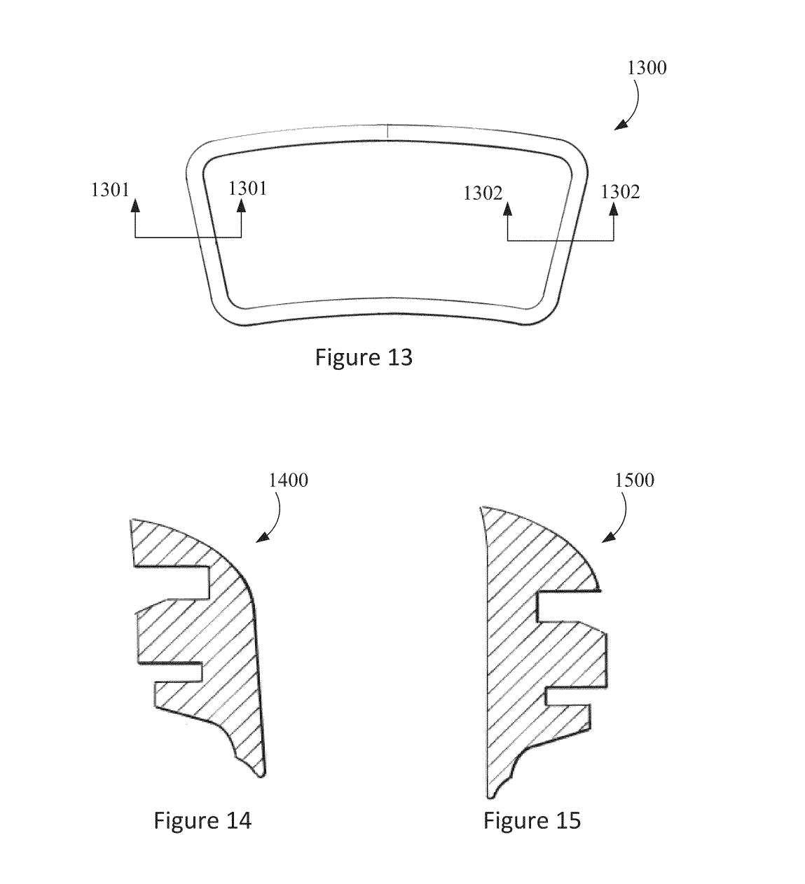

FIG. 13 is an exemplary illustration of a front view of an aft frame. FIG. 14 is an exemplary cross section taken along line 1301-1301 of aft frame 1300. FIG. 15 is an exemplary cross section taken along line 1302-1302 of aft frame 1300. The single aft frame 1300 may have asymmetric contours on the side rails as shown by cross section 1400 and cross section 1500. The asymmetric contours of a single aft frame exit may be contoured in a manner that is oriented towards the stage one nozzle.

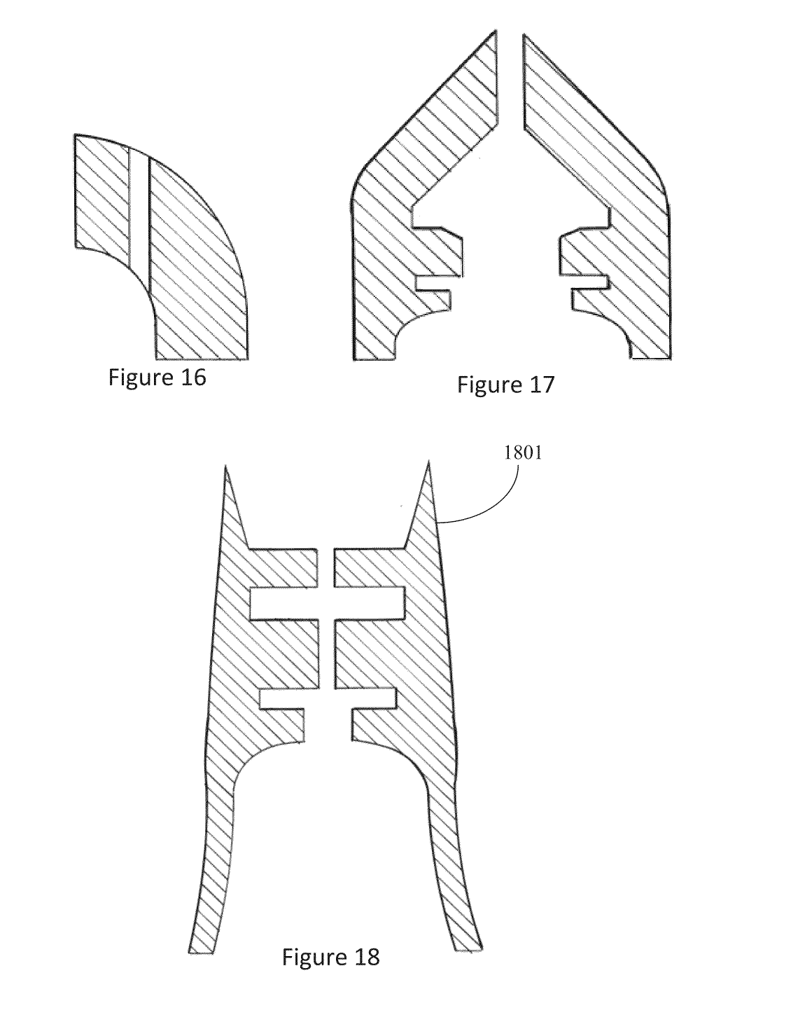

Currently, typical aft frame configurations incorporate cooling holes with circular cross sections in order to divert a portion of flow through an impingement sleeve (which surrounds the transition piece) into these holes to cool the aft frame. Embodiments of the aft frame face as discussed herein that use an airfoil shape of the aft frame exit provide an alternative method of reducing aft frame metal temperatures. Cooling holes on side rails may no longer be needed. Additional backside cooling of the aft frame airfoil may be added to protect the outer thermal barrier coating. Eliminating the flat aft frame face and creating an airfoil shape, may simplify fabrication processes. Cooling holes may be removed on the side rail which may eliminate a percentage of the electrical discharge machining (EDM) holes. In addition, thermal barrier coating (TBC) may be applied down the transition piece body and over the airfoil face to a side seal, which may now cover the entire transition piece surface exposed to hot gas. FIG. 16 is an exemplary illustration of a cross section of an airfoil shaped aft frame. The combination of contour shape and cooling hole angle, as shown in FIG. 16, may produce a film cooling on the transition piece aft end.

FIG. 17 is an exemplary illustration of adjacent aft frames with an airfoil shape transition piece aft frame face that has a more angular shape. FIG. 18 is an exemplary illustration of adjacent aft frames with aft frame side spans designed to spoil the effects of hot gas recirculation and ingestion. Spoiler 1801 of the aft frame exit may separate the flow and reduce the recirculation zone. In addition, cooling or purge holes can be added to the back side of the spoilers to further breakdown the recirculation zone.

Turbines and compressors designs may vary so design-of-experiments (DOE) methods for combining sets of computational fluid dynamics (CFD) and other analysis techniques may be used to optimize the various geometries (e.g., radius of contour of the aft frame) that maximize the results for the particular system. Although side rails of the aft frame are discussed, the entire perimeter of the aft frame face may have an airfoil shape. In addition, although an aft frame is discussed, the embodiments disclosed herein may apply to any apparatus separate from or integrated with the transition piece in a similar position as the aft frame at the transition piece aft end exit.

In describing preferred embodiments of the subject matter of the present disclosure, as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed:

1. An apparatus comprising:
an aft frame, wherein an aft frame exit face of the aft frame has an airfoil shape.

2. he apparatus of claim 1, wherein the airfoil shape is a contoured shape.

3. The apparatus of claim 1, wherein the airfoil shape is based on an interaction of hot gas flow with a stage one nozzle vane.

4. The apparatus of claim 1, the aft frame exit face side rails comprises an airfoil shape.

5. The apparatus of claim 1, wherein the aft frame comprises a first side rail and a second side rail, wherein the first and second side rails are asymmetric.

6. The apparatus of claim 1, wherein the aft frame exit face has backside cooling holes.

7. The apparatus of claim 1, wherein the aft frame has features designed to spoil the effects of hot gas recirculation and ingestion.

8. The apparatus of claim 1, wherein the aft frame exit face has a contour shape and cooling hole angle that produces film cooling on the aft frame exit.

9. A transition piece comprising an aft exit that has an airfoil shape.

10. The transition piece of claim 9, wherein the airfoil shape is a contoured shape.

11. The transition piece of claim 9, wherein the airfoil shape is based on an interaction of hot gas flow with a stage one nozzle vane.

12. The transition piece of claim 9, wherein the aft exit comprises a first side rail and a second side rail, wherein the first and second side rails are asymmetric.

13. The transition piece of claim 9, wherein the aft exit has features designed to spoil the effects of hot gas recirculation and ingestion.

14. The transition piece of claim 9, wherein the aft exit has a contour shape and cooling hole angle that produces film cooling on the aft exit.

15. A system comprising:
a first aft frame comprising an airfoil shape of a face of the first aft frame; and
a second aft frame in proximity to the first aft frame comprising an airfoil shape of a face of the second aft frame.

16. The system of claim 15, the airfoil shape of the first aft frame is based on an interaction of hot gas flow with a stage one nozzle vane.

17. The system of claim 15, wherein the airfoil shape of the first aft frame is a contoured shape.

18. The system of claim 15, wherein the face of the first aft frame has an airfoil shape that is asymmetrical to the face of the second aft frame.

19. The system of claim 15, wherein the aft frame has features designed to spoil the effects of hot gas recirculation and ingestion.

20. The system of claim 15, wherein the aft frame exit face has a contour shape and cooling hole angle that produces film cooling on the aft frame exit.
